(19) United States
(12) Patent Application Publication
(10) Pub. No.: US 2002/0116205 A1
(43) Pub. Date: Aug. 22, 2002

(54) Distributed transaction processing system

(76) Inventors: Lakshmi Narasimha Ankireddipally, Sunnyvale, CA (US); Ryh-Wei Yeh, Palo Alto, CA (US); Dan Nichols, Sunnyvale, CA (US); Ravi Devesetti, Sunnyvale, CA (US)

Correspondence Address: Hickman Palermo Truong & Becker, LLP, 1600 Willow Street, San Jose, CA, 95125-5106, US

(21) Appl. No.: 09/850,521

(22) Filed: May 4, 2001

Related U.S. Application Data
(60) Provisional application No. 60/205,433, filed on May 19, 2000.

(51) Int. Cl. G06F 17/60

(52) U.S. Cl. 705/1

(57) ABSTRACT

A distributed transaction processing system includes a process automation application, referred to as a commerce exchange server, that manages transaction processing and message flow among application programs in a distributed computer network such as the Internet. The system includes a specially designed application interaction protocol that implements the request-reply, publish-notify and broadcast application interaction models. The system also uses a novel transaction definition data structure for specifying the component operations and processing logic that comprise the transaction. The transaction definition data structure allows for the use of conditional logic that specifies constraints on the sequence of operation execution. A transaction service architecture builds a transaction instance data structure to perform the transaction, produces the messages needed for performing the constituent operations that comprise the transaction, and manages the message flow to and from the service applications that perform the constituent operations. The process automation application together with its service applications constitute a domain. The system's architecture permits a process automation application in one domain to interact with a process automation application in a second domain. The application interaction protocol together with the transaction definition data structure permit the process automation application to distribute constituent operations for processing to service applications in different commerce exchange server domains.

### CROSS REFERENCES TO OTHER APPLICATIONS

This application claims the benefit of U.S. Provisional Application No. 60/205,433, entitled “Shared Transaction Processing in a Clustered Process Automation Environment”, filed May 19, 2000. In addition, the subject matter disclosed in this application is related to subject matter disclosed in commonly-assigned U.S. patent application Ser. No. 09/574,334 entitled “Interaction Protocol For Managing Cross Company Processes Among Network-Distributed Applications” (hereafter, “the Protocol patent application”), filed May 19, 2000, and commonly -assigned U.S. patent application Ser. No. 09/574,335 entitled “Transaction Data Structure for Process Communications Among Network-Distributed Applications” (hereafter, “the Transaction Data Structure patent application”), filed May 19, 2000. The entire contents of these applications are hereby incorporated by reference.

### FIELD OF THE INVENTION

The present invention relates generally to systems that manage transaction processing message flow in a distributed computer network such as the Internet. In particular, this invention provides a distributed transaction processing system in which operation components of a transaction are shared between network-distributed software applications in different processing domains.

### BACKGROUND

Business entities have long recognized that substantial productivity and marketing benefits may potentially arise from conducting commercial business activities and business processes over distributed computer networks. In order for a business to achieve the full benefits of network-based commercial activity, the firm's existing commerce-related or business process software application systems must communicate both among each other and with the application systems of other business entities. Earlier efforts at business-to-business commerce activity, such as those led by Electronic Data Interchange (EDI) applications for example, focused on high volume transaction processing for large firms. Because of incompatible application file formats and communications protocols, and requirements for expensive application programming changes to existing systems, EDI applications were largely viewed as being commercially practical for only the largest companies and for only a select number of applications. Moreover, because of a lack of any universal data interchange formats, companies were, and still are, often prevented from exploiting their own enterprise systems integration to reach external partner applications.

In recent years, the Internet distributed computer network has developed the infrastructure and data communications protocols to connect all businesses to each other regardless of their size, geographic location or position in the supply chain. The Internet is a collection of interconnected individual networks operated by government, industry, academia, and private parties that use a set of standard data communications protocols to form a global, distributed network. Networked distributed computer systems may be configured as intranets, extranets or publicly available systems using Internet technologies. Internet technologies provide business entities with another opportunity to achieve substantial productivity gains and marketing benefits by conducting internal, business-to-consumer and business-to-business Internet-based commercial activities among employees, and with customers, vendors, suppliers and other parties related to their business enterprises. Internet-based commercial activities, referred to generally in the current literature as “electronic commerce”, “e-commerce”, or “e-business” include, but are not limited to, all types of business processes that can take place in a secure manner online, as well as the more traditional buying and selling of goods and services. The Internet environment holds out the promise of true collaborative data exchange and software application interoperability for business firms of all sizes.

Several standardization efforts by industry consortia and e-commerce vendors are underway in an effort to achieve Internet application interoperability and seamless transaction processing that will appear transparent to users. One recent standard, Extensible Markup Language (XML), was adopted by the World Wide Web Consortium in February, 1998. In its broadest sense, XML is a system for defining, validating, and sharing document formats on the Web, providing a universal format for structured documents and data. XML is a markup language for presenting documents on the Web that relies on tags and is a meta-language for defining specific subject matter domains of markup tags. XML stores the definitions of tags in files called Document Type Definitions (DTD's). DTD's, also referred to as dictionaries, vocabularies, or schemas, serve as a uniform source of data definitions for specific industries or fields of knowledge, making it easier to exchange data not only within an organization but also among different companies. Further information about XML and the World Wide Web Consortium, also known as W3C, can be found at the W3C Web site, http://www.w3c.org.

Several efforts are underway to standardize transaction processing, many of which use XML. The Internet Open Trading Protocol (IOTP) provides an interoperable framework for Internet commerce that is independent of the particular type of payment system used and is optimized for the case where the buyer and the merchant do not have a prior acquaintance. IOTP describes the content, format and sequences of messages that pass among the participants, referred to as Trading Roles, in an electronic trade. The IOTP framework is centered on an IOTP Transaction that involves one or more organizations playing a Trading Role, and a set of Trading Exchanges. Each Trading Exchange involves the exchange of data, between Trading Roles, in the form of a set of IOTP Messages. Each IOTP Message is the outermost wrapper for an XML document that is sent between Trading Roles that take part in a trade. For more information regarding IOTP, the reader is referred to an Internet-Draft document describing Version 1.0 of the IOTP, published by the Internet Engineering Task Force (IETF) and available at the IETF web site, http://www.ietf.org, as of February, 2000.

The Open Buying on the Internet (OBI, http://www.openbu.org2) standard from the OBI Consortium aims to standardize and secure the corporate purchasing model, especially the high-volume, low-dollar transactions that account for 80% of most organizations' purchasing activities. OBI's goal is to establish a common ground for what is referred to as “The Trading Web,” where OBI standards adopters establish trading relationships with other OBI standards adopters through secured access to extranet facilities connected via the Internet, forming dynamic sets of interoperable systems. OBI defines an architectural approach for e-commerce systems, detailed technical specifications, guidelines for development, record layout formats, file formats, communication structures and protocols, compliance testing guidelines, and implementation assistance. The OBI Consortium may provide support for XML documents in the future. For a complete discussion of the OBI technical specifications, consult version 2.0 of the Open Buying on the Internet standard available at www.openbuy.org/obi/specs/obiv2.html.

RosettaNet is an initiative by a consortium of more than thirty companies in the personal computer (PC) industry, ranging from manufacturers to resellers. Two XML data dictionaries in development will provide a common set of properties required for conducting business among Consortium members. The first is a technical properties dictionary (technical specifications for all product categories), and the second is a business properties dictionary which includes catalog properties, partner properties (i.e., attributes used to describe supply chain partner companies) and business transaction properties. These dictionaries, coupled with the RosettaNet Implementation Framework (RNIF, an exchange protocol), form the basis for an e-commerce dialog known as the Partner Interface Process or PIP. RosettaNet's PIP's are specialized system-to-system XML-based dialogs that define how business processes are conducted between electronic component and information technology products manufacturers, software publishers, distributors, resellers and corporate end users. For further information the reader is referred to the RNIF document designated as version 1.1 and published Nov. 8, 1999, discussing the RNIF in detail, available at More information about RosettaNet is available at the Web site, http://www.rosettanet.org.

Private vendors, such as Ariba Technologies Inc., Commerce One Inc., and Concur Technologies Inc., use XML to simplify the process of matching up RFPs and purchase orders over the Web. The Ariba Network platform, for example, provides a range of Internet services for buying and selling organizations, including supplier directories, supplier catalog and content management, access to supplier content, and secure transaction routing. A protocol known as Commerce XML (cXML) serves as a meta-language to enable the development of “intelligent shopping agents” to assist with the corporate purchasing function.

XML and related data representation standardization efforts, combined with industry-based e-commerce standards efforts, clearly expand the reach of Internet-based e-business to a wider range of enterprises and are efforts in the direction of an integrated Internet e-commerce environment. The tremendous promise of electronic commerce is certain to create large distributed transaction processing systems that must be robust and reliable. However, many of these efforts do not directly address the issues of processing efficiency, flexibility and reliability in a large distributed network environment such as the Internet. What is needed is a transaction processing architecture that supports flexible and efficient processing options in a distributed network environment.

### SUMMARY

The present invention is premised on the observation that a distributed network marketplace must provide robust and efficient processing capabilities to the parties (users) who participate in the marketplace. A comprehensive e-commerce solution must provide a framework, or architecture, that allows for dynamic sharing of resources among process automation applications in different domains. Such a solution should also be platform independent to support a wide variety of computing environments.

The present invention provides a transaction processing architecture for a process automation application, referred to as a commerce exchange server. The transaction processing architecture is premised on a user-centric view in which a transaction is a single unit of work from the perspective of the requesting application, or client. The transaction may require several processing components to achieve its end result. However, once the user defines those components and their process flow using a unique and novel transaction definition data structure, the commerce exchange server produces the messages needed to perform the transaction and manages the message flow to and from the service applications without further intervention from the user.

The transaction processing architecture makes use of a novel transaction definition data structure that is described in detail in the concurrently filed Transaction Data Structure patent application. This data structure allows the user to define a transaction composed of component operations and to define the order of those operations, including determining whether an operation is a broadcast operation or whether more than one operation should be performed concurrently before proceeding to a next operation. The data structure also allows the user to specify the source of input data needed to perform each operation and to place conditional logic on the execution of an operation, based on results of one or more previously executed operations. The transaction definition data structure allows a transaction to be specifically customized to the business needs of the user who defines the transaction.

The commerce exchange server, including the transaction processing architecture that makes use of the novel transaction definition data structure, may be implemented in any type of distributed network of processor-controlled machines such as, for example, in the Internet environment. A specially designed application interaction protocol governing message exchanges in the Internet environment is disclosed in the Protocol patent application referenced above.

The combination of the novel transaction definition data structure and the specially designed application interaction protocol enable the commerce exchange server and its transaction processing component to automatically direct the processing of component operations within a single transaction to service applications in different domains. This allows for the completion of a transaction even if there are no service applications available to process a component operation in the domain of the commerce exchange server. Shared transaction processing in this manner allows for more robust, reliable, and efficient transaction processing, making the maximum use of distributed system resources.

Therefore, in accordance with one aspect of the present invention, there is provided a distributed transaction processing system comprising a first process automation application domain. The first process automation application domain includes a first plurality of service application programs each capable of performing an operation, a requesting application program producing a transaction request message indicating a transaction including a plurality of operations, and a first computer having a memory device for storing a first process automation application. The first process automation application receives the transaction request message from the requesting application program and produces an operation request message for each operation included in the plurality of operations. The distributed transaction processing system further comprises a second process automation application domain including a second plurality of service application programs each capable of performing an operation, and a second computer having a memory device for storing a second process automation application. The second process automation application is configured to receive operation request messages from the first process automation application. The distributed transaction processing system further comprises a common application interaction protocol for exchanging messages between the first and second process automation applications, between the first process automation application and the first plurality of service applications and between the second process automation application and the second plurality of service applications. The first process automation application sends the operation request messages to at least one of the first plurality of service application programs and to the second process automation application for processing by at least one of the second plurality of service application programs. The first process automation application produces a transaction response message using operation response messages received from the second process automation application and from the first plurality of service applications, and sends the transaction response message to the requesting application.

The novel features that are considered characteristic of the present invention are particularly and specifically set forth in the appended claims. The invention itself, however, both as to its organization and method of operation, together with its advantages, will best be understood from the following description of an illustrated embodiment when read in connection with the accompanying drawings. In the Figures, the same numbers have been used to denote the same component parts or steps.

### BRIEF DESCRIPTION OF THE DRAWINGS

FIG. 1 is a block diagram schematically illustrating a systems architecture for managing transaction processing in a distributed computer network according to the present invention;

FIG. 2 illustrates the application interaction semantics for Request and Reply messages, according to the application interaction protocol implemented in the system of FIG. 1;

FIG. 3 illustrates the application interaction semantics for Publish and Notify messages, according to the application interaction protocol implemented in the system of FIG. 1;

FIG. 4 is a block diagram showing the types of messages and the general message flow of a transaction between the transaction service component and the service and requesting applications of FIG. 1;

FIG. 5 is a block diagram schematically illustrating the major entities of the transaction data structure used in the transaction processing system of FIG. 1;

FIG. 6 is a flowchart illustrating transaction processing as performed by the transaction service of FIG. 4 and using the transaction definition data structure of FIG. 5, according to an illustrated implementation;

FIG. 7 is a simplified block diagram schematically illustrating cooperating commerce exchange applications in different domains, according to an illustrated implementation of the present invention;

FIG. 8 is a simplified block diagram schematically illustrating the registration process between primary commerce exchange servers to establish the shared transaction environment of FIG. 7, according to an illustrated embodiment of the present invention;

FIG. 9 is a simplified block diagram schematically illustrating a first primary commerce exchange server sending a transaction request to a second primary commerce exchange server in a different domain, according to an illustrated embodiment of the present invention;

FIG. 10 is a simplified block diagram schematically illustrating a first primary commerce exchange server sending an operation request to a second primary commerce exchange server in a different domain, according to an illustrated embodiment of the present invention;

FIG. 11 is a simplified block diagram illustrating the distributed processing of a single transaction across a cluster of two commerce exchange servers, according to an illustrated embodiment of the present invention; and

FIG. 12 is a simplified block diagram illustrating a distributed computer network including several processor-controlled machines, showing the components of one suitably configured processor-controlled machine in which the present invention may be used, and further illustrating the software product of the present invention and its use in conjunction with a machine in the network.

### DETAILED DESCRIPTION OF EMBODIMENT(S)

1. Overview of the Commerce Server Architecture.

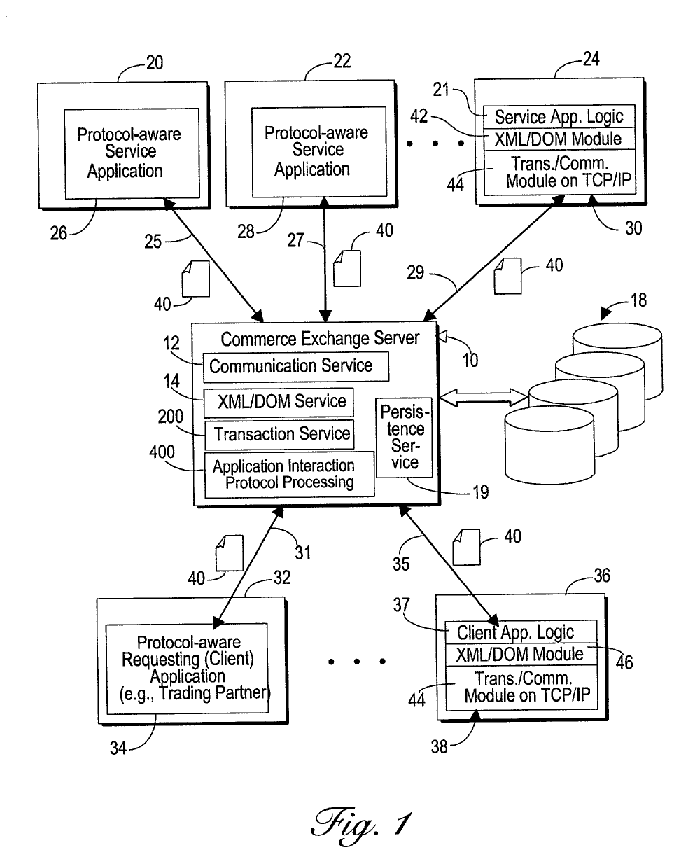

FIG. 1 illustrates a system architecture for enabling application-to-application interaction in a distributed computer network. Specifically, the system architecture of FIG. 1 illustrates an inter- or intra-enterprise Internet-based electronic commerce architecture including process automation application 10, referred to as a commerce exchange (CX) server. CX server 10 operates as a type of clearinghouse, receiving operation requests posted by client components 34 and 38 and directing them to appropriate service components 26, 28 and 30 identified (“signed up”) to CX server 10 as being available to perform those services. In this capacity, much of the processing performed by CX server 10 involves searching for service component by service operation and searching for client components by their identification numbers. CX server 10 also performs a variety of administrative functions including transaction tracking and audit functions and disaster recovery functions.

Each application component is referred to as a commerce exchange component, or CXC. As shown in FIG. 1, there may be any number of CXCs identified to CX server 10. A CXC application either provides one or more services or originates a transaction request, or both. A CXC application may be integrated with CX server 10 as a built-in component residing on the same machine or it may be a third party application resident on a different machine. For example, service application 30 is resident on machine 24 and accessible to CX server 10 via communications connection 29, and requesting application 38 is resident on machine 36 and accessible to CX server 10 via communications connection 35. The type of architecture model illustrated in FIG. 1 may be variously described in the literature as an information bus model, a client-server model or a cooperative agent model.

CX server 10 includes several processing services: Communication service 12; XML/DOM service 14; Transaction service 200; and Persistency service 19. Communication service 12 provides interfaces for accepting and establishing connections, and sending and receiving messages through various network transport protocols. In an illustrated implementation of CX server 10, the network transport protocol supported is TCP/IP, but other transport protocols may be supported as well. Communication service 12 also provides a variety of other communications-related services including notification of broken connections, fragmentation and assembly of messages, and connection-level session management and handshaking functions.

Persistency service 19 provides interfaces for storing information into and retrieving information from external data stores 18. From the perspective of CX server 10 or a CXC, data entering into or coming from data stores 18 are in XML document format. Persistency service 19 has the responsibility of mapping between an XML document and the respective data store schema. In an illustrated implementation of CX server 10, data stores 18 include a Netscape™ message server, a Netscape™ LDAP server, and an Oracle™ database server. Support for flat files is also possible. Examples of information that are included in data stores 18 are system parameters, events and alerts, and transaction definitions.

XML/DOM service 14 provides interfaces and services for handling the XML documents 40 that form the basis of the application interaction protocol. Services include parsing and constructing XML documents, and building and accessing DOM (Document Object Module) object trees. XML/DOM service 14 may make use of any public domain XML parser. The Document Object Model (DOM) is a platform- and language-neutral application programming interface (API) for HTML and XML documents that models these documents using objects. The DOM provides a standard set of objects for representing HTML and XML documents, a standard model of how these objects can be combined, and a standard interface for accessing and manipulating them. As an object model, the DOM identifies the semantics of these interfaces and objects, including both behavior and attributes, and the relationships and collaborations among these interfaces and objects. Because of its platform- and language-independent format, the DOM is used as an interface to proprietary data structures and APIs, instead of product-specific APIs, in order to achieve application interoperability with less effort. Additional information regarding the DOM may be found at http://www.w3.org/DOM/.

CX server 10 executes as a single process that listens to one listener port and one administrative port for application protocol (CXIP) messages. The single process model distinguishes CX server 10 from conventional application servers that follow the traditional multi-process model. The single process model is critical to the implementation of conditional-logic transaction processing and the complexities of event notification and process control over the CXCs. Moreover, the single process model simplifies administration of the CX server 10 by the system administrator, and is more efficient in database access than a multi-process model. In addition, a single multi-threaded process is typically more efficient than multiple single or multi-threaded processes because it uses fewer system resources such as memory and disk space, assuming that each thread is scheduled as having the same priority as the kernel thread. The capability of deploying a backup CX server addresses the problem of a single point of failure caused by using a single process model.

CX server 10 supports both a single-thread and multi-thread model. A single-threaded CX server listens to both the administrative and listener ports at the same time and processes incoming request one after another, in serial fashion. Priority processing is not supported and event processing support is restricted. The single-thread model does not allow for the CX server to load CXC libraries. The multi-threaded CX server uses multiple threads for listening and accepting connections from the administrative port, listening and accepting connections from the listener port, listening and receiving messages from established connections, priority processing of transactions (messages), and executing CXC libraries loaded as part of the process. The multi-threaded model supports both serial and non-serial processing of requests. Serial and non-serial processing are distinguished by whether the message listening thread waits for termination of the thread that is created to process the message. Threading and serialization are determined by configuration parameters provided at startup.

In one embodiment of CX server 10, a commerce exchange component (CXC) is expected to establish a persistent connection, throughout the lifetime of the CXC, to the CX server and to use the connection for all message exchanges. The CX server uses the connection to determine the existence of the CXC in the network. Each message received through a persistent connection is processed concurrently using an independent thread. This implementation improves message-processing performance, minimizes the usage of system resources, and eliminates the overhead of establishing and terminating a connection for each new request.

In the illustrated implementation of CX server 10 herein, CX server 10 supports asynchronous transaction processing. That is, when an operation request is sent from CX server 10 to a CXC, the processing thread does not block for a response from the CXC and instead sets the state of the transaction and exits from the thread. When a response message is received, the transaction is executed based on the state and the type of response. Support for asynchronous transaction processing achieves efficiency from the single shared connection between CX server 10 and a CXC. Requests may be sent from the CX server simultaneously in multiple threads and the responses may be returned in any order according to how the CXC process them, without waiting for the requests to be performed serially. In addition, timer events may be introduced more easily, thus creating an event-driven processing model.

2. Application Interaction Protocol Processing.

With continuing reference to FIG. 1, CX server 10 also includes an application interaction protocol processing function 400. CX server 10 is a document-centric process automation application, exchanging messages in the form of XML documents 40 between CXCs. These XML documents form the underlying application interaction protocol, referred to as the Commerce Exchange Interaction Protocol, hereafter CXIP. Standardizing the message format in this manner allows for the straightforward integration of third party applications as CXCs, without the absolute requirement for application-specific libraries. Each CXC includes two software interface components (not shown) for extracting transaction data from XML-based message 40. A transportation/communication module handles the syntax and semantics of the Application interaction message received from CX server 10 over the particular communications transport mechanism (e.g., TCP/IP), receiving a message and returning an XML document. Then, an XML/DOM (Document Object Model) module receives the XML document output produced from the transportation/communication module, parses the document and returns one or more DOM objects that are passed to the application logic for handling as standard program objects. The use of DOM objects is discussed in more detail below. A CXIP message is in the data representation format specified by XML, which is presumed to be an 8-bit character format in the present implementation. Sending and receiving applications have the responsibility of encoding and decoding data embedded inside a CXIP message.

The CXIP application interaction protocol supports three of the most common types of application interaction models in the e-commerce environment. These models are generally known as request/reply, publish/subscribe and broadcast. In an illustrated implementation of the commerce exchange server, the request/reply interaction model allows two parties to exchange information in an asynchronous, or non-blocking, fashion. In asynchronous messaging, the requesting application sends a transaction request to the commerce exchange server and may continue its own processing, without waiting for the transaction to be processed. An acknowledgement response is sent that contains tracking information that allows the requesting party to query the status of the transaction request. In a publish/subscribe interaction model, two applications interact via an intermediary party. The applications that are interested in specific information register with the intermediary party. The information generating application posts, or publishes, the information to the intermediary, which in turn passes this to the registered parties. In this model, the information requestor and the information supplier never interact directly. The broadcast model is a special case of a model known as the multicast model, both of which send a message to the members of a group of parties who support the requested operation. When the group size is less than the entire membership of a domain, a message is broadcast to the group; when the group size equals the entire membership, sending the message to the entire group is referred to as multicasting. The message sent in this type of interaction model is typically one of two types: a request message, resulting in a reply message returned, or a notify message that simply reports information or events. Note also that in the multicast interaction model, the recipient group may or may not be subscription based. The information receiver application determines this from the content of the broadcast message. The transaction model of the present invention provides support for all three interaction models.

The application interaction protocol reflects an interaction framework that is independent of the subject matter domain and participants' roles in the transactions. While transaction-specific data is necessarily defined and provided within the content of the XML message, CX server 10 manages message type sequencing and timing according to the more generic values of the message type attribute. CXIP supports eight (8) message types in order to implement the three interaction models. These message types are Request, Reply, Cancel, Publish, Notify, Subscribe, Unsubscribe, and Acknowledge. These are described in detail in Table 1.

TABLE 1

| Sender Message | Receiver's Response | Description |
|---|---|---|
| Request | Acknowledge | Sender (Client) requests a |
| | | service and the Receiver |
| | | (Server) sends an acknow- |
| | | ledgement to that request. |
| Reply | Acknowledge | Sender (Server) responds to a |
| | | service request and the |
| | | Receiver (Client) returns an |
| | | acknowledgement. |
| Cancel | Acknowledge | Sender (Client) requests to |
| | | cancel a service request and the |
| | | Receiver (Server) acknow- |
| | | ledges the cancel request |
| Publish | Acknowledge | Sender (Publishing Agent) |
| | | publishes an event to the |
| | | Receiver (Broker). Receiver |
| | | (Broker) acknowledges the |
| | | message. |
| Notify | Acknowledge | Sender (Broker) notifies the |
| | | subscribed Receiver(s) of an |
| | | event. Receiver(s) acknow- |
| | | ledge receipt of the message. |
| Subscribe | Acknowledge | Sender (Subscriber) sends a |
| | | Subscribe message and |
| | | Receiver (Broker) sends an |
| | | acknowledgement. |
| Unsubscribe | Acknowledge | Sender (Subscriber) sends a |
| | | Unsubscribe message and |
| | | Receiver (Broker) sends an |
| | | acknowledgement. |
| Acknowledge | Not Applicable | Sender sends an acknowledge- |
| | | ment message and expects |
| | | nothing in return. |

An Acknowledge message is a special type of message used to acknowledge receipt of all of the other message types. An Acknowledge message may contain any information needed for tracking purposes, such as for querying the status of a prior request, or purposes of establishing an audit trail or transaction log. An application should follow the application interaction protocol by sending an Acknowledge message for each received message, except for the Acknowledge message itself. Application interaction models may be implemented in either synchronous or asynchronous mode. An illustrated implementation of CX server 10 operates in asynchronous mode, also referred to as the offline, or non-blocking, model. The Protocol patent application provides additional details about an illustrated implementation of the application interaction protocol.

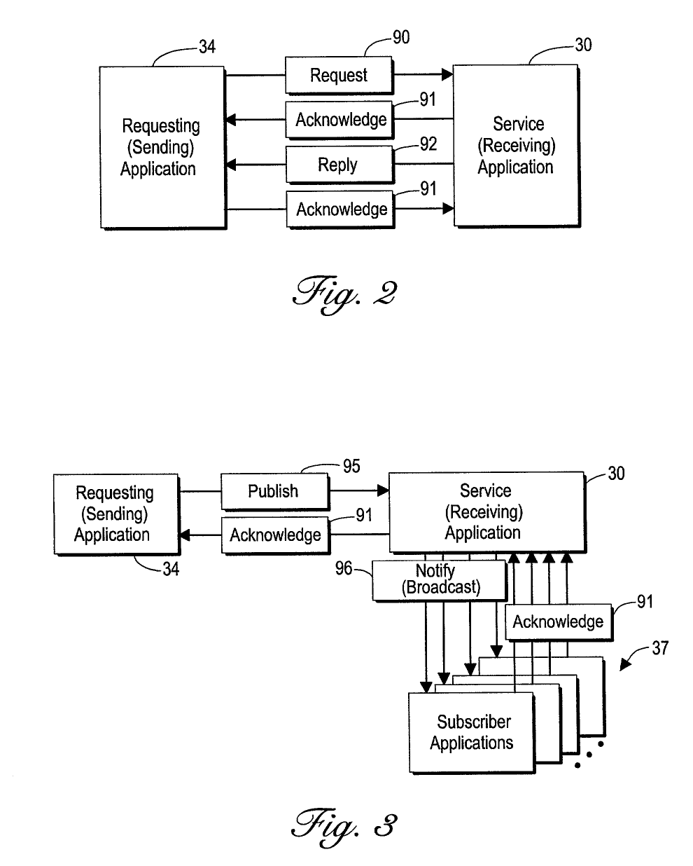

In FIG. 2, requesting application 34 sends a Request message 90 to service application 30. Request message 90 encodes service invocation semantics in the message. The SERVICE attribute of the CONTROL section specifies the target service, and the INPUT element of the DATA section contains arguments required to perform the service. Service application 30 sends an Acknowledge message 91 in response to receipt of a Request message. Then service application 30 sends a Reply message 92 to originating application 34 after completion of and in response to the service invoked by Request message 90. A Reply message 92 may include input and output parameters, service results, request status, and other application-specific data. Application 34 sends an Acknowledge message 91 in response to receipt of a Reply message 92.

FIG. 3 illustrates the Publish message 95 and the Notify message 96. A Publish message 95 sent by requesting application 34 embeds one or more events in its content section. Service application 30 immediately sends an Acknowledge message 91 in response to receipt of a Publish message 95. Service application 30, as the receiving party, eventually relays the event or events through Notify message 96 to each of the subscribers 37 to the particular event. A Notify message 96 is used to report the occurrence of one or more events. The Notify message may result from a specific trigger event, or from receipt of a Publish message 95. Each of the receiving parties 37 of a Notify message immediately sends an Acknowledge message 91 to service application 30 in response to receipt of Notify message 96.

The basic transport assumption in the application interaction protocol, CXIP, used by CX server 10 is the guaranteed delivery of messages. As long as this requirement is satisfied, the underlying transport protocol may be any standard communications protocol. As noted above, the present implementation of CXIP is based on TCP/IP. In this implementation, CXIP messages are transmitted as TCP data between applications. A field size data item in the fixed-length message header of a CXIP message indicates the length of the associated message content in byte counts so that the receiver may easily determine the end of a message without having to test for a special message-termination character. CXIP may also be implemented on top of other transport mechanisms such as SMTP and FTP. Cooperating applications (CXCs) based on different transportation mechanisms (e.g., SMTP or FTP ) are implemented by including a bridging mechanism in Communication service 12 (not shown) for translating messages between TCP/IP and SMTP and FTP message formats. To enable HTTP-based interactions a MIME type may be defined, such as “application/x-cxip-v10”, and it is straightforward to develop a browser plug-in to handle CXIP messages.

3. Transaction Service.

Transaction service 200 provides interfaces for working with transaction logic, tracking a transaction thread, traversing transaction logic and performing transaction execution. CX server 10 provides a virtual workspace, or transaction execution space, to participating CXC applications. A CXC submits a transaction request based on a published CX transaction document type declaration (DTD). Upon receipt of a transaction request, CX server 10 identifies the set of operations that comprise the transaction based on a transaction definition in data store 18, and then executes the transaction by providing operation requests to CXCs identified as signing up to perform the respective operations. Each invoked CXC performs the specified operation request(s) and sends back results to CX server 10, which, after completion of all operation requests, returns the transaction response back to the originating CXC. A transaction definition takes the form of a directed acyclic graph. CX server 10, with knowledge of the transaction logic from the transaction definition, controls all processing decisions including which operations to perform, to which CXC to forward an operation request, how to process the conditions on the services, which information to pass and receive, and when to terminate processing.

a. Overview of Transaction Message Types and Message Flow.

Preliminary to describing transaction processing and its associated data structures, definitions are provided for some terminology that has specific meanings in the context of the present invention. These terms have the meanings given here throughout this disclosure, rather than any meanings that may occur in other sources, such as, for example, in documents, if any, that are incorporated by reference herein elsewhere in this description.

The term data or data item refers herein to physical signals that indicate or include information. Data includes data existing is any physical form, and includes data this is transitory or is being stored or transmitted. For example, data could exist as an electromagnetic or other transmitted signal or as a signal stored in electronic, magnetic or other form. A data structure as used herein is any combination of interrelated data items. For example, an XML document is a data structure. A data item indicates a thing, an event or a characteristic when the item has a value that depends on the existence or occurrence or the measure of the thing, event or characteristic. A first item of data indicates a second item of data when the second item of data can be obtained from the first item of data, when the second item of data can be accessible using the first item of data, when the second item of data can be obtained by decoding the first item of data, or when the first item of data can be an identifier of the second item of data.

An operation is a single, atomic process that acts upon input data to achieve a unit level function. An operation may sometimes be referred to as a service. The CX server handles an operation as a single unitary process, while the scope and nature of the processing involved in an operation is defined by the service application that performs the operation. A transaction is a set of one or more operations that are to be performed in a defined order under given conditions by one or more participating service applications.

A transaction definition is a data structure that defines a type or category of valid transaction to CX server 10. A transaction definition includes the component operations that constitute the transaction, the identity of the input data items required to perform each operation and the source of values for that data. A transaction definition also includes process flow information that indicates conditional logic, if any, to be applied to a component operation, and the data items and format of the output results of the transaction. Note that a transaction definition may include only one transaction. A transaction database is a collection of one or more transaction definitions. Each transaction definition includes a unique identifier within a given domain referred to herein as a transaction definition name.

Every transaction definition conforms to a transaction directed acyclic graph data structure, or transaction DAG. That is, the transaction DAG specifies the ordered set of data items that are both required and optional for a transaction definition. A directed acyclic graph is known in the art as a set of nodes and a set of ordered pointers between the nodes that define at least one path through the graph, subject to the constraint that no path starts and ends with the same node.

A transaction instance data structure, or transaction instance, is a specific implementation of a transaction definition that indicates the specific data to be used to perform the transaction defined by the transaction definition. Thus, a transaction definition may be viewed as providing a template for producing a transaction instance when provided with specific input data on which to operate. A transaction instance has a unique identifier within a given domain, referred to as a transaction ID, associated with it.

In the illustrated implementation of the transaction service described below, a transaction definition is specified using Extensible Markup Language, or XML, and so is a data object called an AML document. XML describes a class of data objects called XML documents and partially describes the behavior of computer programs that process them. XML is an application profile or restricted form of SGML, the Standard Generalized Markup Language [ISO 8879]. By construction, XML documents are conforming SGML documents. Each XML document has both a logical and a physical structure. Physically, the document is composed of units called entities. An entity may refer to other entities to cause their inclusion in the document. A document begins in a “root” or document entity. Logically, the document is composed of declarations, elements, comments, character references, and processing instructions, all of which are indicated in the document by explicit markup declarations. The logical and physical structures must nest properly, as described in “4.3.2 Well-Formed Parsed Entities” in the World Wide Web Consortium XML specification. A software module called an XML processor is used to read XML documents and provide access to their content and structure. It is assumed that an XML processor is doing its work on behalf of another processing entity or module.

An XML document type declaration contains or points to markup declarations that provide a grammar for a class of documents. This grammar is known as a document type definition, or DTD. The document type declaration can point to an external subset containing markup declarations, or can contain the markup declarations directly in an internal subset, or can do both. The DTD for a document consists of both subsets taken together. An XML document is valid if it has an associated DTD and if the document complies with the constraints expressed in its associated DTD. An XML document is a well-formed XML document if the document, taken as a whole, matches the XML production labeled “document,” meets all the constraints with respect to being well-formed given in the XML specification, and each of the parsed entities referenced directly or indirectly within the document is well-formed. A well-formed XML document may also be valid if it meets additional criteria, as specified in World Wide Web Consortium, Extensible Markup Language (XML) 1.0: W3C Recommendation Feb. 10, 1998.) Additional information about XML is available at htt ://www.w3.org/XML and www.w3.org/TR/PR-xm1-971208.

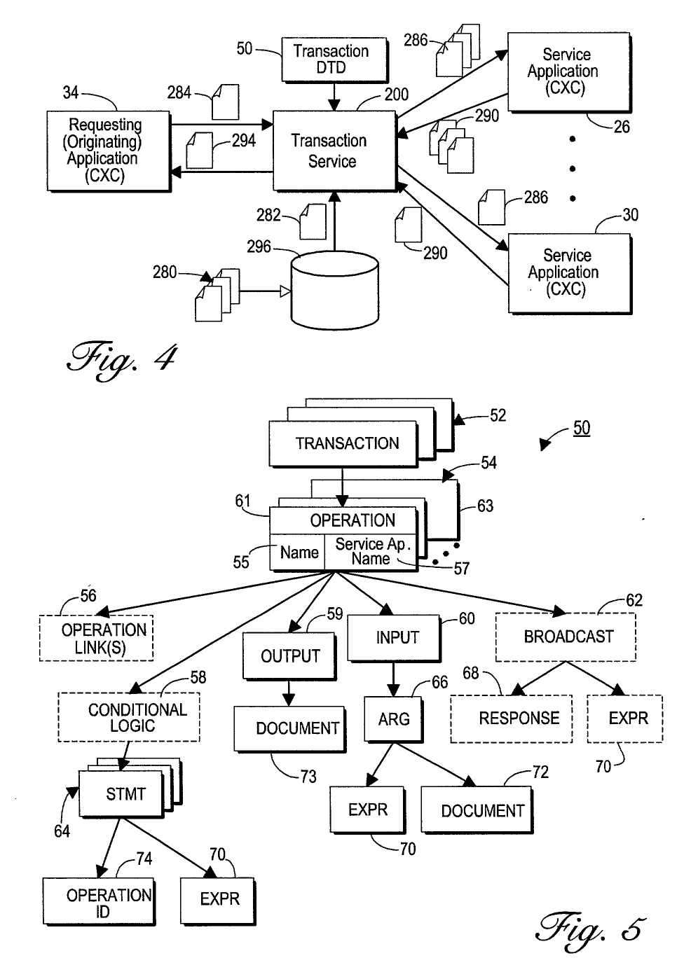

FIG. 4 illustrates the components of an illustrated embodiment of the transaction service architecture and the message types associated with a transaction instance. Transaction service 200 is responsible for producing some of the messages involved in performing a transaction, and for managing the message flow necessary to perform a transaction. FIG. 4 shows the transaction message flow and assumes that messages are received by CX server 10 and, after processing by other components (e.g., communications service 12 and application interaction protocol processing service 400), are passed to transaction service 200. There are four types of messages managed by transaction service 200. These are a transaction request message, an operation request message, an operation response message, and a transaction response message. Note that in the illustrated embodiment of CX server 10 described herein, each of the four types of messages is an XML document that conforms to the application interaction protocol handled by application interaction protocol processing service 400 (FIG. 1) and described in the Protocol patent application.

A requesting (or originating) application 34 submits a transaction request 284 to transaction service 200. Transaction request 284 is a data structure that indicates a request to process a transaction according to the transaction definition identified by a transaction definition name included in transaction request 284. A transaction is single unit of work from the perspective of the requesting application, or client. In the transaction processing model of CX server 10, every transaction has one and only one input document and one and only one output document, although each input and output document may have multiple sub-document components. Transaction service 200 receives request 284 and uses the transaction definition name to obtain the appropriate transaction definition 282. In the illustrated implementation of transaction service 200, all transaction definitions 280 included in transaction database 296 are loaded into memory at the start-up of CX server 10. However, transaction service 200 could also retrieve the appropriate transaction definition 282 from among all transaction definitions 280 included in transaction database 296.

Transaction service 200 uses transaction DTD 50, transaction definition 282 and transaction request 284 to produce a transaction instance data structure (not shown). The transaction instance is an internal data structure that transaction service 200 uses to perform the requested transaction. In an illustrated embodiment of transaction service 200, the transaction instance data structure is a directed acyclic graph. Transaction service 200 uses transaction definition 282 and transaction request 284 to produce a transaction instance, which includes information about each operation in the transaction. Each operation is uniquely identified within the transaction instance and includes the name of the service application that is to perform that operation. For every operation included in the transaction instance, transaction service 200 produces an operation request document 286. Operation request document 286 is sent to a service application 26 (a CXC) to perform the operation. Transaction service 200 obtains the input data needed for execution of the named operation from transaction request 284 and provides it in operation request document 286 according to specifications provided in the transaction instance.

With continued reference to FIG. 4, transaction service 200 may send several operation request documents 286 to a single service application 26, and may send operation request documents 286 from a single executable transaction to several service applications 26 and 30. When a service application 26 completes an operation, it produces an operation response document 290 indicating the results of the operation and sends operation response document 290 to transaction service 200. Operations within a transaction instance are performed according to an order specified in transaction definition 282. Thus, transaction service 200 tracks the receipt of operation response documents both to determine what operation(s) to perform next and to determine when a transaction instance is complete. Transaction service 200 may use operation results included in an operation response document 290 to produce a subsequent operation request document 286 for a subsequent operation to be executed.

When all operations of a transaction instance have been completed, transaction service 200 produces a transaction response document 294, using operation response documents 290, and the transaction instance. Transaction service 200 obtains from the transaction instance the format in which the originating requesting application expects to receive the output results of a completed transaction, and prepares transaction response document 294 using the results provided in operation response documents 290. Then, as shown in FIG. 4, transaction service 200 returns transaction response document 294 to requesting (originating) application 34.

b. Functional Components of a Transaction.

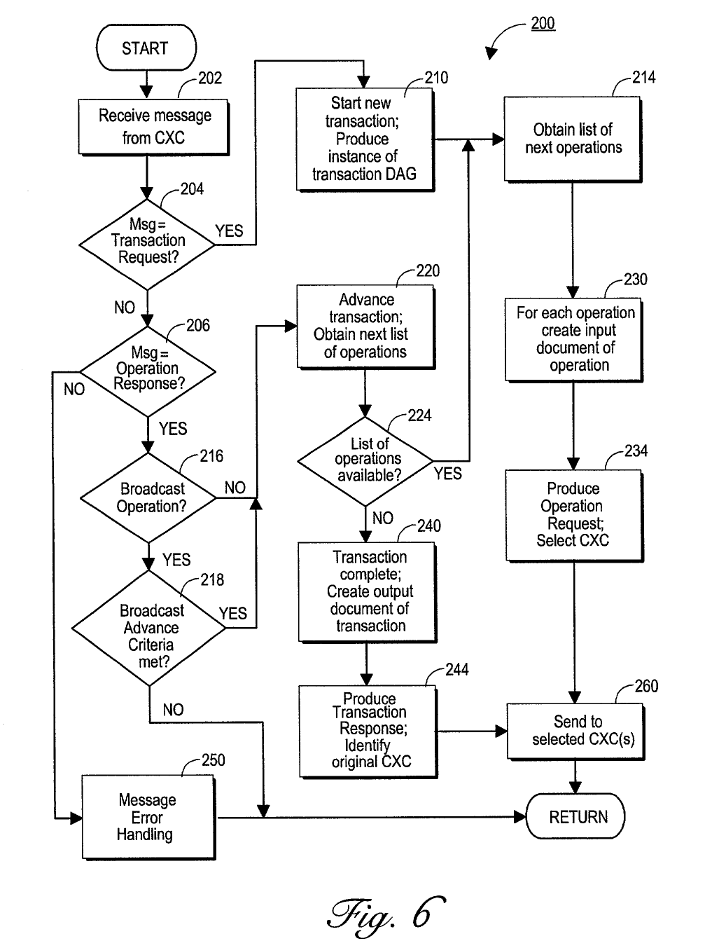

Transaction definition 282 of FIG. 4 serves as a template for a specific transaction instance and is an XML document having the logical and physical structure specified by its associated transaction DTD 50. The general organization and major functional entities of the transaction directed acyclic graph data structure 50 are schematically illustrated in FIG. 5, with each functional entity shown as a named rectangular box. The identifying data entity names used in FIG. 5 are not intended to limit the data structure in any way. The data entities are illustrated in a hierarchy to show each entity's constituent parts. An entity that may have more than one occurrence is illustrated by multiple offset boxes. Each occurrence includes all of the entities at lower levels in the hierarchy. Entities that are composed of the same data items are labeled with the same reference numbers. An entity that is required is shown with its box in solid outline while the box of an optional entity is shown with a dark dashed outline. A required entity indicates that either the data is explicitly included in the data structure or the necessary data is obtained from some other source by default. The entities that exist below an optional entity in the hierarchy are shown as being either required or optional for the case when the optional higher level entity is present in the transaction. Because an XML DTD expresses both a logical and a physical structure, some of the data entities have logical processing associated with them. The entities and their processing behaviors are defined as follows. Note that the interpretation of DTD 50 described below are defined by a specific implementation of transaction service 200, and are not associated with the DAG data structure. For example, the default behaviors that are described below when no value is provided for a tag or when an optional section is missing indicate the specific interpretation of the illustrated embodiment described herein. The interpretation of DTD 50 described below thus reflect an illustrated embodiment of transaction service 200, and other interpretations are also possible.

A transaction instance is composed of a set of ordered operations 54. In the directed acylic graph, an operation is represented by a node in the graph. Every transaction has two specific nodes, or operations, called the head operation and the tail operation. Operations 61 and 63 are shown as the head and tail operations respectively. Operation flow within a transaction always proceeds from the head operation to the tail operation. There may be one or more operations between the head and tail operations but each operation is performed only once. Note that if the operation is a broadcast operation, it is still considered to be performed only once, even though the operation may be sent to many service applications to be performed. There may be more than one possible path through the graph from the head operation to the tail operation, and one of those possible paths is executed at runtime. Thus, the path through the graph for a given transaction definition will not necessarily be the same for each transaction instance of that transaction definition because of differing run time conditions.

Each operation is defined to include five functional entities: name 55, Service application name 57, INPUT 60, CONDITIONAL LOGIC 58 and OPERATION LINK(S) 56. These entities provide the information used to produce the operation request document 286 used by a service application to perform this operation and to provide conditional logic to determine which operation(s) is to be performed after the completion of this operation. A unique operation name 55 represents the operation within the context of its transaction. A service application, or CXC, name 57 specifies the service application that can perform this operation. Note that the name of the operation can be determined at run-time by looking up a CXC that has signed up to perform that operation.

The INPUT entity, which is the only required entity, provides information sufficient to prepare the operation's operation request document 286 (FIG. 4). A list of expressions 60, referred to as INPUT entity logic, is used to build the input arguments for the operation request message 286 for the operation to which this INPUT entity belongs. If the processing for the INPUT entity fails, the operation will not be executed. If no INPUT entity is provided, a default INPUT consolidates all of the preceding operations' operation response documents 290 into the operation request document 284 for this operation. The ARGUMENT component 66 provides an argument to add to the operation request document 286 for this operation. It specifies the name and type of the argument along with a tag indicating if it is required or optional. The associated EXPRESSION component 70 defines how to derive the value for this argument. An argument may derive its input data from another document, or generate a value based on some EXPRESSION. DOCUMENT component 72 identifies an XML document and defines how that document should be mapped to the indicated argument (ARG). It defines the operation that contains the document and the relevant section(s) of the document to extract. Transaction DAG structure 50 also includes runtime data in the form of OUTPUT entity 59 which includes DOCUMENT entity 73, for use in assembling the output response document.

The OPERATION LINK((S) component 56 refers to explicit links between the present (source) operation and a destination (next) operation. Operation links define the order of execution of the operations. When one operation completes its execution, the operation links specify the set of operations that may be executed as a result. An operation is ready for execution when all other operations that have forward links to this operation have completed execution. Note that this includes operations that are considered complete for any reason, including timeout, failure, or elimination due to split condition logic.

An important feature of DAG structure 50, and the reason that there may be more than one possible path through a transaction instance graph, is that the execution of one or more of OPERATIONS 54 (except for operations 61 and 63) may be conditioned on the output of previous operations. Conditional execution is accomplished using the CONDITIONAL LOGIC (CL) entity 58. CL entity 58 is used to decide which operations to consider for execution whenever the operation to which the CL entity belongs completes execution. It is comprised of a series of statements (STMT) 64 that include an EXPRESSION entity 70 which is evaluated, typically using the output results of the completed operation. For each statement that evaluates to a true condition, the list of operations held by that statement in the OPERATION ID entity 74 is returned for consideration for possible execution. If there is no CL entity for an operation, all operations identified as destination operations in the OPERATIONS LINK entity will be considered for possible execution.

An optional entity in transaction DAG structure 50 is the BROADCAST entity 62. The presence of BROADCAST entity 62 indicates that the operation is a broadcast operation and should be sent to more than one service application for processing. The optional subsections place success criteria on the broadcast operation to determine when to advance the operation as a whole. If RESPONSE entity 68 is present, a data value indicates that there are a minimum number of successful responses expected before this operation may be advanced. If EXPRESSION entity 70 is present, it specifies that an action should be performed and a value returned and evaluated before this operation may be advanced. An expression can be a simple value, a math operation, the value of a variable, or the return value of a function.

In an illustrated embodiment of the present invention, the transaction DAG data structure has the structure of the document type definition (DTD) shown in Table 1. The INPUT entity, CONDITIONAL LOGIC entity and OPERATION LINK(S) entity of FIG. 5 are referred to as JOIN section, SPLIT section, and OPLINK section, respectively, in Table 2.

TABLE 2

| | |
|---|---|
| <!DOCTYPE CXTXDAG | [ |
| <!ELEMENT CXTXDAG | (TRANSACTION)*> |
| <!ATTLIST CXTXDAG | |

| | | |
|---|---|---|
| NAME | CDATA | #REQUIRED |
| VERSION | (1.0 \| 2.0 \| ...) | \“1.0\” |
| OBJMODEL | (ECXpert \| ...) | \“ECXpert\” |

>

| | |
|---|---|
| <!ELEMENT TRANSACTION | (OPERATION)*> |
| <!ATTLIST TRANSACTION | |

| | | |
|---|---|---|
| NAME | CDATA | #REQUIRED |
| TIMEOUT | CDATA | #IMPLIED |
| SAVE | CDATA | #IMPLIED |

| | |
|---|---|
| > | |
| <!ELEMENT OPERATION | (OPLINK*\| SPLIT \| JOIN)> |
| <!ATTLIST OPERATION | |

| | | |
|---|---|---|
| OPID | CDATA | #REQUIRED |
| NAME | CDATA | #REQUIRED |
| CXCNAME | CDATA | #REQUIRED |
| BROADCAST | CDATA | #IMPLIED |
| TIMEOUT | CDATA | #IMPLIED |

| | |
|---|---|
| > | |
| <!ELEMENT OPLINK | EMPTY> |
| <!ATTLIST OPLINK | |

| | | |
|---|---|---|
| SRCOPID | CDATA | #REQUIRED |
| DSTOPID | CDATA | #REQUIRED |

| | |
|---|---|
| > | |
| <!ELEMENT SPLIT | (STMT)*> |
| <!ATTLIST SPLIT | |

| | | |
|---|---|---|
| NAME | CDATA | #REQUIRED |

| | |
|---|---|
| > | |
| <!ELEMENT STMT | (EXPR, OPID+)*> |
| <!ATTLIST STMT | |

| | | |
|---|---|---|
| NAME | CDATA | #REQUIRED |

| | |
|---|---|
| > | |
| <!ELEMENT EXPR | (VALUE \| OPERATOR \| VAR \| |

FUNCTION) *>

<!ATTLIST EXPR

| | | |
|---|---|---|
| NAME | CDATA | #REQUIRED |

| | |
|---|---|
| > | |
| <!ELEMENT OPID | EMPTY> |
| <!ATTLIST OPID | |

| | | |
|---|---|---|
| ID | CDATA | #REQUIRED |

```
  >
  <!ELEMENT OPERATOR (VALUE | OPERATOR | VAR |
```

FUNCTION) *>

<!ATTLIST OPERATOR

| | | |
|---|---|---|
| MATHOP | CDATA | #REQUIRED |

| | |
|---|---|
| > | |
| <!ELEMENT VAR | EMPTY> |
| <!ATTLIST VAR | |

| | | |
|---|---|---|
| VARNAME | CDATA | #REQUIRED |
| VALTYPE | CDATA | #IMPLIED |
| OPID | CDATA | #IMPLIED |
| INPUTDOC | CDATA | #IMPLIED |

| | |
|---|---|
| > | |
| <!ELEMENT VALUE | EMPTY> |
| <!ATTLIST VALUE | |

| | | |
|---|---|---|
| STRVALUE | CDATA | #IMPLIED |
| NUMVALUE | CDATA | #IMPLIED, |

>

| | |
|---|---|
| <!ELEMENT FUNCTION | EMPTY> |
| <!ATTLIST FUNCTION | |

| | | |
|---|---|---|
| LIBNAME | CDATA | #REQUIRED |
| FUNCNAME | CDATA | #REQUIRED |
| VALTYPE | CDATA | #IMPLIED |

| | |
|---|---|
| > | |
| <!ELEMENT JOIN | (FUNCTION \| ARG*) > |
| <!ELEMENT ARG | (EXPR) > |
| <!ATTLIST ARG | |

| | | |
|---|---|---|
| VARNAME | CDATA | #REQUIRED |
| VALTYPE | CDATA | #IMPLIED |

>
] >

c. Operation of the Transaction Service.

The general functions of transaction processing service 200 of FIG. 4 are illustrated in the flowchart of FIG. 6. These functions are described below with reference to the components shown in FIG. 4. CX server 10 receives messages from requesting applications and service applications. CX server 10, after handling message protocol functions, passes these received messages to transaction service 200 in box 202. CX server 10 uses transaction service 200 to track a transaction thread, to traverse transaction logic and to perform transaction execution. Transaction service 200 provides a set of service interfaces or procedures with conditionals and mapping of DOM objects for working with the transaction logic.

As shown in FIG. 4, transaction service 200 handles four types of messages; it may receive transaction request messages 284 and operation response messages 290, and it may send operation request messages 286 and transaction response messages 294. Transaction service 200 first determines what kind of message has been received in the query boxes 204 and 206. If the message is neither one, control passes to a message error handling procedure 250 and processing control returns to CX server 10. If the message is a transaction request message 284, this is a new transaction, and control passes from box 204 to box 210, where transaction service 200 calls a procedure named StartTransaction to create a new transaction instance associated with a unique identifier, referred to as the transaction ID, and to start transaction execution. Creating a new transaction includes calling a procedure named CreateTransaction to retrieve the transaction definition 282 that matches the transaction name in request message 284 from transaction definition database 296, and producing the directed acyclic graph that represents the transaction instance. Transaction service 200 then begins traversing the transaction instance graph by obtaining a list of operations for execution, in box 214, using the SPLIT logic of the head operation. For each operation in the operation list, transaction service 200 calls the procedure Get InputMSG to create the input document(s) for the operation, in box 230, using the information specified in the JOIN section for the operation, and produces the operation request document 286, in box 234. For each operation, transaction service determines the service application name of the service application that is to perform the operation, using the CXCNAME tag. Then, transaction service 200 returns the operation request document(s) CX server 10 for sending to their respective service applications, in box 260, and control returns to CX server 10.

If the incoming message is not a transaction request, as determined in box 204, transaction service 200 queries whether it is an operation response 286 received from a service application, in box 206. If the message is an operation response, transaction service 200 updates the transaction state. Each operation response message contains the transaction ID, the operation name and the output results produced by the service application, and is stored in a data store for later access and processing. The transaction state changes every time an operation response message is received.

Transaction service 200 then determines, in box 216, whether the operation response message is in response to a broadcast operation. A broadcast operation may involve invoking more than one service application to perform the operation. In the illustrated implementation of transaction service 200, the criteria for advancing to a next operation node is to wait until all responses to operations associated with the node are received. To determine whether a broadcast operation is completed, the RESPONSE, MIN and EXPR tags are used to determine how to process operation response messages. As noted earlier, if the RESPONSE section is present, the MIN tag specifies the minimum number of responses required to be received before advancing past this operation. If no RESPONSE section is defined, the default is that all operation requests sent on behalf of this broadcast operation must be received before the operation as a whole can be advanced. If the EXPR section is present, this indicates an expression that must be evaluated against each response received to determine if it should be counted toward the minimum. If no EXPR section is present, all responses received will be counted toward the minimum, if a minimum has been specified. Collectively these rules may be referred to as the broadcast advance criteria. If the query in box 216 determines that this operation response message is in response to a broadcast operation, then Transaction service 200, in box 218, queries whether the broadcast advance criteria have been met, and if so, control proceeds to box 220 to advance the transaction. If broadcast advance criteria have not been met, then this operation node is not complete, the transaction cannot be advanced, and control is returned to CX server 10.

If the message is an operation response message and there is no pending broadcast operation, transaction service 200 calls procedure AdvanceTrans action in box 220. Transaction service 200 then calls procedure GetTransaction to update the transaction instance's state information, and then evaluates the SPLIT logic of the operation associated with this operation response message to obtain the next list of operations from the transaction instance graph. Transaction service 200 queries, in box 224, whether there is a next operations list available. If a next list of operations is available, then CX server 10 still has more operations to perform for this transaction, and the transaction may be advanced to have the appropriate service application(s) perform the next operations. Transaction service 200 ensures that none of the operations in the list of next operations has a predecessor operation that is still pending and has not yet completed. Control passes to boxes 230, 234 and 260 where the next operation request message(s) are produced and sent out, as described above.

If the query in box 224 indicates that there is no next operations list, the transaction has been completed (assuming that the incoming message is not in error). This means that the operation response message just received is for an operation whose SPLIT logic or OPLINK section points to the required tail operation in the transaction instance. The tail operation node is available as the next operation in the next operation list. Control then passes to boxes 240 and 244 where the transaction response message is created. The JOIN logic of the tail operation node contains the transaction response document format expected by the requesting (originating) application. Transaction service 200 calls a procedure named GetOutputMSG to obtain the output document for the transaction, produces the transaction response message using this document format, identifies the requesting application and then sends the transaction response message to that application in box 260.

4. Distributed Transaction Processing Support.

Returning briefly to FIG. 1, the transaction processing architecture supports transaction processing in a distributed computer network such as the Internet in several ways. CX server 10 makes use of the Document Object Model (DOM) described above. Service application 30 and requesting (client) application 38 each includes transportation/communication module 44 for handling the syntax and semantics of application interaction message 40 received from CX server 10 over a TCP/IP transport mechanism. Transportation/communication module 44 receives message 40 as TCP/IP data and returns an XML document. In service application 30, XML/DOM module 42 receives the XML document output produced from transportation/communication module 44, parses the document and returns one or more DOM objects that are passed to service application logic 21 for handling as standard program objects. Similarly, in requesting application 38, transportation/communication module 44 receives message 40 as TCP/IP data via communications path 35 and returns an XML document. XML/DOM module 46 then receives the XML document output produced from transportation/communication module 44, parses the document and returns one or more DOM objects that are passed to application logic 37 for handling as standard program objects. This component module application architecture enables any third party application to be straightforwardly integrated as a commerce exchange component (CXC) in the domain of a commerce exchange server. Development of these component modules is technically straightforward in either Java or C++ implementations.

A primary CX server, or primary CX, is a commerce exchange server that is actively communicating with associated CXCs to exchange CXIP messages for the purpose of commerce transaction execution. A backup CXserver, or backup CX, is a commerce exchange server that is passively engaged in a CX domain waiting to assume the role of the primary CX upon abnormal termination of the primary CX. A CX domain is an instance of CX server 10 with one and only one primary CX server, zero or more backup CX servers, and zero or more CXCs associated with the primary CX. A CX domain has a unique identifier that identifies a specific instance of a CX domain. A commerce exchange component, or CXC, is any entity, application or library loaded by the primary CX that communicates with the primary CX through CXIP messages.

A CX server in one domain may communicate with a CX server in another domain to cooperatively fulfill transaction requests. The import of this architectural feature is that a CX server in one enterprise or network may communicate with a CX server in another enterprise or network to cooperatively fulfill transaction requests, and an enterprise or group of enterprises may deploy cooperating commerce exchange applications. Thus, one CX server 10 that cannot fulfill a service component of a transaction request using a participating (i.e., registered) CXC in its own domain may send the operation request to another CX server that includes a participating CXC that has the capability to perform the service. Note also that, while FIG. 1 shows TCP/IP as the message transport protocol, transportation module 44 may be implemented on top of SMTP or FTP as well. Cooperating applications (CXCs) based on different transportation mechanisms may also be implemented by developing a bridge that translates messages from one protocol to another.

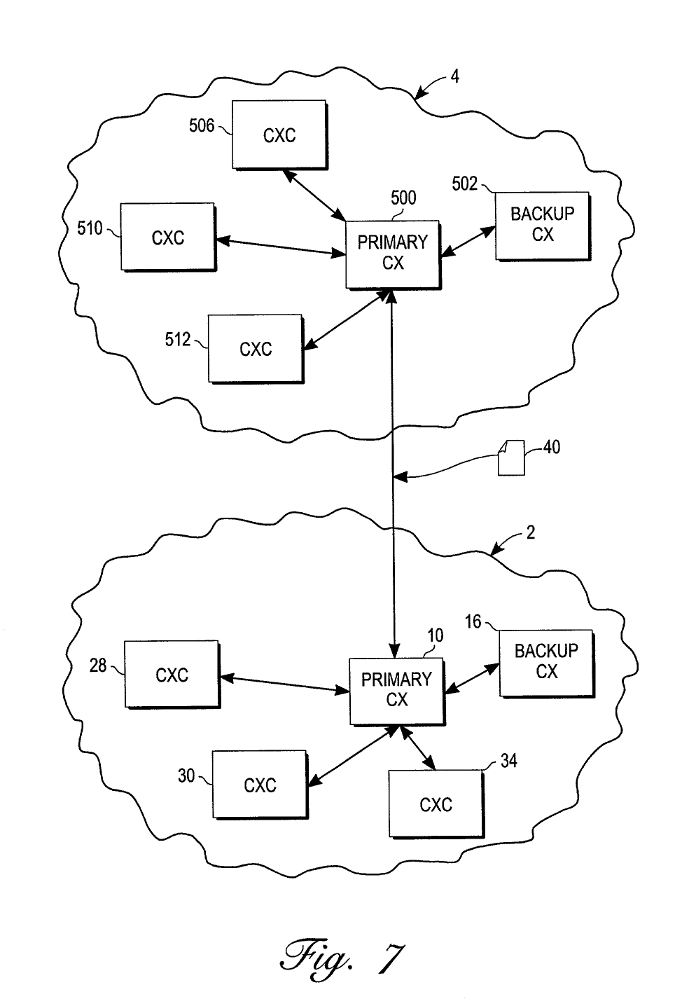

FIG. 7 illustrates cooperating primary commerce exchange servers 10 and 500 in domains 2 and 4, respectively. Each domain has several registered CXCs and a backup CX. Cooperating primary commerce exchange servers 10 and 500 exchange application interaction documents 40.

There are several interaction processes that are enabled between components in a distributed commerce exchange network. These processes include registration and “un-registration” processes, operation signup and “un-signup” processes, transaction request and transaction cancellation processes, operation request and operation cancellation processes, subscription and “un-subscription” processes, a notification process and a hello process. The hello process is used to validate the communication channel and to test if the receiving party is active. These interaction processes may occur from CX to CXC in the same domain, from CXC to CX in the same domain, from a primary CX in a first domain to a primary CX in a second domain, from a primary CX in a first domain to a backup CX in the same domain, and from a backup CX in a first domain to a primary CX in the same domain.

Several of these interactions are important to the implementation of the distributed processing of a single transaction by multiple primary CX servers such as CX servers 10 and 500 in FIG. 7. First, the registration process between primary CX servers establishes a shared transaction environment. A primary CX registers to another primary CX in a different CX domain to form a cluster of CX domains. The connected CX domains can then perform transactions in a cooperative fashion. FIG. 8 illustrates the register interaction. Primary CX 10 in domain 2 sends register request 520 to primary CX 500 in domain 4. Consistent with the CXIP protocol, primary CX 500 returns acknowledge message 522. Although not shown in FIG. 8, primary CX 10 may terminate its registration with primary CX 500 by sending an “un-register” request.

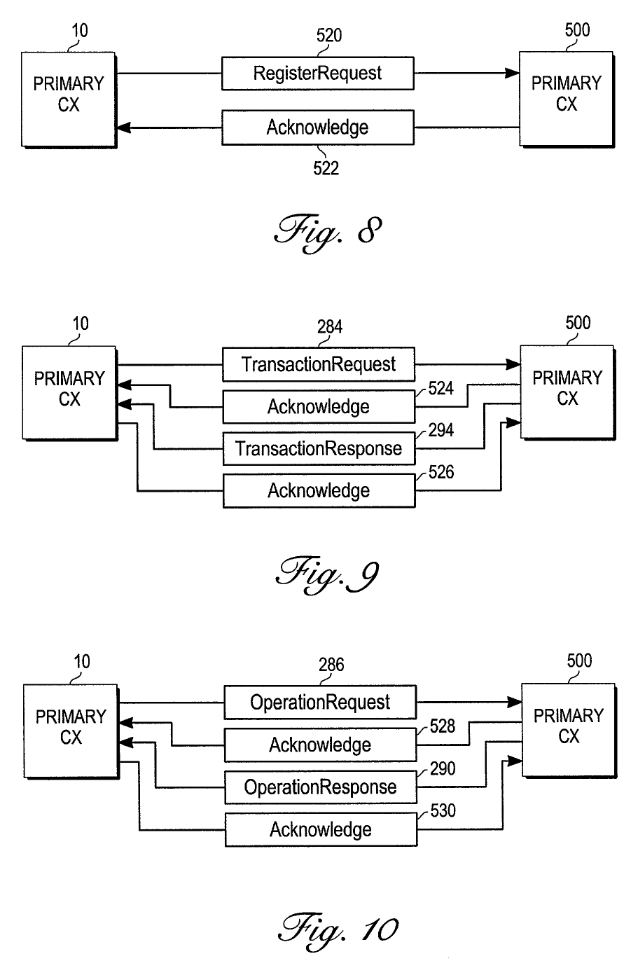

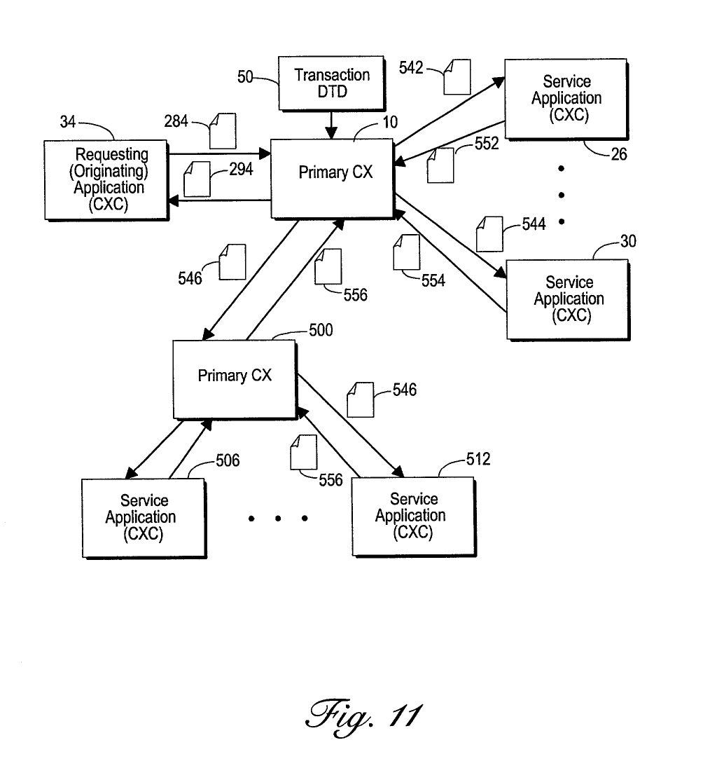

Once a first primary CX is registered to a second primary CX, the first primary CX may send requests to perform transactions (FIG. 9) and requests to perform operations (FIG. 10) to the second primary CX. With reference to FIG. 9, first primary CX 10 sends transaction request 284 to primary CX 500. Typically, primary CX 10 looks to another commerce exchange server to process a transaction on its behalf when primary CX 10 does not support the transaction in transaction definition data base 296 (FIG. 4). Primary CX 500 returns acknowledgement 524 to primary CX 10. Primary CX 500 then either processes the transaction indicated by transaction request 284, as described above in conjunction with the discussion accompanying FIG. 6, or determines that it does not support the transaction (i.e., the transaction definition is not included in its transaction definition data base). Primary CX 500 returns a transaction response document 294 to primary CX 10. Although not shown in FIG. 9, primary CX 10 may cancel a pending transaction previously sent to primary CX 500 by sending a transaction cancellation request to primary CX 500.

With reference now to FIG. 10, first primary CX 10 sends operation request 286 to primary CX 500. Typically, primary CX 10 looks to another commerce exchange server to process an operation on its behalf when primary CX 10 does not support the operation. This would occur when primary CX 10 has no registered CXCs that perform the operation. Primary CX 500 returns acknowledgement 524 to primary CX 10. Primary CX 500 then either processes the operation indicated by operation request 286, as described above in conjunction with the discussion accompanying FIG. 6, or determines that it does not support the operation (i.e., primary CX 500 has no registered CXCs that perform the operation). Primary CX 500 returns an operation response document 290 to primary CX 10. Although not shown in FIG. 10, primary CX 10 may cancel a pending operation previously sent to primary CX 500 by sending an operation cancellation request to primary CX 500.

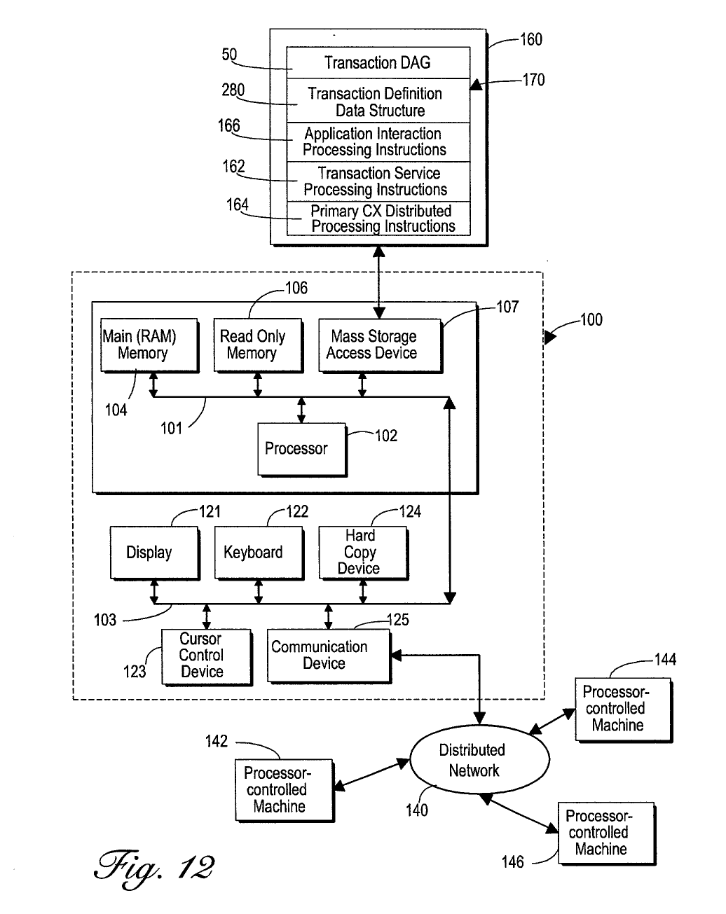

FIG. 11 is a simplified block diagram illustrating the distributed processing of a single transaction across a cluster of two commerce exchange servers. Requesting CXC 34 submits transaction request 284 to primary CX server 10 to perform a transaction identified by its unique transaction definition name within the CX server 10 domain. The requested transaction has a transaction definition stored in data memory (not shown) or loaded into the memory of CX server 10. Transaction service 200 (not shown) of primary CX 10, upon receipt of transaction request 284, identifies the set of operations that comprise the transaction based on a transaction definition, and then executes the transaction by providing operation requests to CXCs identified as registering to perform the respective operations. In FIG. 11, the operation requests that comprise the requested transaction are shown as operation request documents 542, 544 and 546. By way of illustration, the domain of primary CX 10 does not include a CXC registered to perform the operation designated in operation request 546. When it is time to perform operation request 546, primary CX 10 sends operation request document 546 to primary CX 500, which identifies a CXC 512 that has registered to perform operations of the type designated in operation request document 546. Primary CX 500 then sends operation request document 546 to CXC 512, and CXC 512 performs the designated operation, returning an operation response document 556 to primary CX server 500. Primary CX server 500 returns operation response document 556 to primary server 10, which consolidates the output data from all of the operation response documents 552, 554 and 556 into a transaction response document 294 for sending to the original requesting application 34. As noted above, primary CX servers 10 and 500 may be geographically remote from each other or may be commerce exchange servers in different enterprises.

5. The Machine and Software Product of the Invention.

FIG. 12 is a block diagram of distributed network 140 that includes processor-controlled machines 142, 144, 146 and 100. The component parts of machine 100 have been enlarged to schematically illustrate a machine in which the present invention may be used. Machine 100 is an example of a processor-controlled machine that may be used to implement commerce exchange server 10 of FIG. 1 including transaction service 200 which utilizes the transaction DAG data structure. Similarly, any one of the processor-controlled machines 142, 144 and 146 may implement one of machines 20, 22 or 24 of FIG. 1 that include a service application or one of machines 32 or 36 that include a client application of the commerce network illustrated in FIG. 1. While the present invention may be used in any machine having the common components, characteristics, and configuration of machine 100, the invention is not inherently related to any particular processor, machine, system or other apparatus. The machine or system may be specially constructed and optimized for the purpose of carrying out the invention. Alternatively, machine 100 may comprise a general-purpose computer selectively activated or reconfigured by a computer program stored in the computer. In still another alternative machine 100 may be a combination of a general-purpose computer and auxiliary special purpose hardware. When a machine such as machine 100 is suitably programmed to embody or make use of the present invention, the machine is not a standard or known configuration. In the claims, machine 100 is referred to as a “computer” for purposes of simplifying the claim language, but the term “computer” is intended to include any and all machines as described and shown in FIG. 12 and is not intended to limit the scope of machine 100 in any way.

Machine 100 includes a bus or other internal communication means 101 for communicating information, and a processor 102 coupled to bus 101 for processing information. Machine 100 further comprises a random access memory (RAM) or other volatile storage device 104 (referred to as main memory), coupled to bus 101 for storing information and instructions to be executed by processor 102. Main memory 104 also may be used for storing temporary variables or other intermediate information during execution of instructions by processor 102. Machine 100 also comprises a read only memory (ROM) and/or static storage device 106 coupled to bus 101 for storing static information and instructions for processor 102, and a data mass storage access device 107 such as a magnetic disk drive or optical disk drive. Data mass storage access device 107 is coupled to bus 101 and is typically used with a computer readable mass storage medium 160, such as a magnetic or optical disk, for storage of information and instructions. Machine 100 may include more than one storage access device 107. For example, machine 100 may include both a storage access device for a non-removable medium such as an internal magnetic (hard) disk and a mass storage access device for a removable medium such as an optical CD-ROM, a magnetic floppy disk, a PC-card, or magnetic tape.

Machine 100 may, but need not, include a conventional display device 121 capable of presenting images, such as a cathode ray tube or a liquid crystal display (LCD) device or any other device suitable for presenting images. Display device 121 is coupled to bus 101 through bus 103 for displaying information to a computer user. An alphanumeric input device 122, including alphanumeric and other keys, may also be coupled to bus 101 through bus 103 for communicating information and command selections to processor 102. An additional user input device is cursor control device 123, such as a mouse, a trackball, stylus, electronic tablet, or cursor direction keys coupled to bus 101 through bus 103 for communicating direction information and command selections to processor 102, and for controlling cursor movement on display device 121. Another device which may optionally be coupled to bus 101 through bus 103 is a hard copy device 124 which may be used for printing instructions, data, or other information on a medium such as paper, film, or similar types of media. Note that the actual manner in which the physical components of machine 100 are connected may vary from that shown in FIG. 12. The manner of connection may include hardwired physical connections between some or all of the components, as well as connections over wired or wireless communications facilities, such as through remote or local communications networks and infrared and radio connections. Note further that not all of the components of machine 100 shown in FIG. 12 may be required to carry out the distributed processing functions of commerce exchange server 10 of the present invention. Those of ordinary skill in the art will appreciate that various configurations of machine 100 may be used to carry out a particular implementation of commerce exchange server 10. For example, machine 100 may be a Workgroup Enterprise server machine manufactured by Sun Microsystems, Inc. of Mountain View California that includes one or more Ultra SPARC™ processors, and that operates using the Solaris™ operating system.

Machine 100 further includes communication, or network interface, device 125, coupled to bus 101 through bus 103, for use in sending data to and receiving data from other nodes of distributed network system 140 according to standard network protocols. This communication device 125 may include any of a number of commercially available networking peripheral devices such as those used for coupling to an Ethernet, token ring, Internet, or wide area network.

Processor 102, together with an operating system, operates to execute instructions (e.g., program code) to produce and use data. The program code and data may reside in main memory (RAM) 104, in read only memory 106, on the non-removable hard disk storage accessed by storage access device 107, or even on another processor-controlled machine connected to network 140. The program code and data may also reside on a removable medium that is loaded or installed onto machine 100 when needed by means of a storage access device 107 suitable for that purpose. When program code (i.e., software) implementing commerce exchange server 10 is stored in a memory device accessible to processor 102, machine 100 is configured to perform the functions of commerce exchange server 10 of FIG. 1, and, in particular, to process transactions having the structured format illustrated in FIG. 5. An input transaction request message, such as transaction request message 284 of FIG. 4, is provided from communication device 125 and is forwarded via data bus 103 to bus 101 for storage in main memory 104 for later access by processor 102. Processor 102 executes program instructions, included in one of the above-described memory components, that implement operation 200 of FIG. 6, and operations 12, 14, 400 and 19 of FIG. 1. During execution of the instructions, processor 102 accesses memory 104 or 106 to obtain or store data necessary for performing its operations. For example, when machine 100 is configured to perform operation 500 of FIG. 6, processor 102 may access transaction DTD 50 (FIG. 5) in memory 104 in order to perform the functions of transaction service 200 for starting a new transaction instance.

FIG. 12 also shows software and data structure product 160, an article of manufacture that can be used in a machine that includes components like those shown in machine 100. Software and data structure product 160 includes data storage medium 170 which stores instructions, also referred to as program code or computer readable code, for executing operations that process transactions as defined by the present invention, such as operation 200 of FIG. 6. Data storage medium 170 also stores one or more data structures, such as Transaction DAG 50 of FIG. 5 for use in producing transaction instances and executing transactions. As used herein, a “data storage medium” covers one or more distinct units of a medium that together store a body of data. Examples of data storage media include magnetic media such as floppy disks, diskettes, magnetic tape, and PC cards (also previously known as PCMCIA memory cards), optical media such as CD-ROMs, and semiconductor media such as semiconductor ROMs and RAMs. By way of example, a set of magnetic disks or optical CD-ROMs storing a single body of data would be a data storage medium.

Software and data structure product 160 may be commercially available to a purchaser or user in several forms. In one typical form, software and data structure product 160 is commercially available in the form of a shrink-wrap package that includes data storage medium 170 and appropriate documentation describing the product. In that case, data storage medium 170, also referred to as a computer-readable medium, is a physical medium that stores one or more data structures or instruction data that is accessed by storage medium access device 107 or its equivalent. “Storage medium access device” is a device that can access data stored on a data storage medium. Storage medium access device 107 may be contained in a distinct physical device into which data storage medium 170 is inserted into, mounted on, or otherwise installed into, in order for the storage medium access device to access and retrieve the data stored thereon. Examples of storage medium access devices include disk drives, CD-ROM readers, and DVD devices. A storage medium access device may be physically separate from machine 100, or enclosed as part of a housing of machine 100 that includes other components. Mass storage device 107 may also be remotely located (not shown) as part of some other processor-controlled machine, such as a server, on network 140. Mass storage device 107 may provide instructions retrieved from medium 170 to processor 102 via bus 101, causing processor 102, when executing the instructions, to process transactions in accordance with the teachings herein. Mass storage device 107 may provide one or more data structures retrieved from medium 170 to processor 102 via bus 101, for use in processing transactions in accordance with the teachings herein. If device 107 is remotely located, program instructions and data structures are provided from storage medium 170 to processor 102 of machine 100 by way of communication device 125 from network 140.

Software and data structure product 160 may also be commercially or otherwise available to a user in the form of a data stream indicating instruction data for processing transactions or one or more data structures for use in processing transactions in accordance with the teachings herein. The data stream is transmitted to the user over a communications facility from a remotely-located storage device. In this case, article 160 is embodied in physical form as signals stored on the remotely-located storage device; the user accesses the contents of data storage medium 170 in order to purchase or otherwise obtain a copy of those contents, but typically does not purchase or acquire any rights in the actual remotely-located storage device. When software product 160 is provided in the form of a data stream transmitted to the user over a communications facility from the remotely-located storage device, instruction data and data structures stored on data storage medium 170 are accessible via communications device 125. Alternatively, a data stream transmitted to the user over a communications facility from the remotely-located storage device may be stored in some suitable local memory device of machine 100 or a data storage medium 107 locally accessible to processor 102 using bus 101.

FIG. 12 illustrates various examples of how data storage medium 170 may be configured. Software and data structure product 160 may include one or more of the types of data illustrated in FIG. 12. For example, data storage medium 170 may be configured with transaction definition data structure 280 of FIG. 4 and transaction DTD data structure 50 of FIG. 5 for use by transaction service 200 for producing a transaction instance DAG data structure and executing a transaction according to the process flow in FIG. 6.

Data storage medium 170 may also be configured with transaction service processing instruction data 162 for performing operation 200 (FIG. 6) or with primary CX distributed processing instructions 164. The instruction data 162, 164 and 166 are provided to processor 102 for execution when transaction service processing is to be performed. For example, when instructions 162 are provided to processor 102, and processor 102 executes them, machine 100 is operated to perform the operations for starting or advancing a transaction, processing a broadcast transaction, producing operation request messages, or producing a transaction response message, according to operation 200 of FIG. 6. Note also that when software and data structure product 160 comprises the entire commerce exchange server application 10 of FIG. 1, data storage medium 170 may include additional instruction data (not shown) for carrying out operations 12, 14, 19 and 400 of CX server 10.

While the invention has been described in conjunction with one or more specific embodiments, this description is not intended to limit the invention in any way. Accordingly, the invention as described herein is intended to embrace all modifications and variations that are apparent to those skilled in the art and that fall within the scope of the appended claims.

What is claimed is:

1. A method, implemented by a first transaction manager, for processing a transaction, comprising:
receiving a transaction request;
determining at least one particular operation to be performed to process said transaction request;
determining whether any of a plurality of service providers accessible to the first transaction manager are able to perform said particular operation;
in response to a determination that none of the plurality of service providers accessible to the first transaction manager are able to perform said particular operation:
sending a first operation request to a second transaction manager to ask the second transaction manager to coordinate performance of said particular operation;
receiving a first operation response from the second transaction manager after said particular operation has been performed;
preparing a transaction response based, at least partially, upon said first operation response; and
sending said transaction response to a sender of said transaction request.

2. The method of claim 1, further comprising:
in response to a determination that at least one of the plurality of service providers accessible to the first transaction manager is able to perform said particular operation:
sending a second operation request to a particular service provider that is able to perform said particular operation;
receiving a second operation response from the particular service provider after said particular service provider has performed said particular operation; and
preparing said transaction response based, at least partially, upon said second operation response.

3. The method of claim 2, wherein said first operation request and said second operation request are the same request.

4. The method of claim 2, wherein said first operation request and said second operation request are different requests.

5. The method of claim 1, wherein said transaction request comprises one or more sets of data, and wherein each set of data is accompanied by a specification that specifies a type of value being represented by that set of data.

6. The method of claim 1, wherein said transaction request comprises an XML document.

7. The method of claim 1, wherein said operation request comprises one or more sets of data, and wherein each set of data is accompanied by a specification that specifies a type of value being represented by that set of data.

8. The method of claim 1, wherein said operation request comprises an XML document.

9. The method of claim 1, wherein said operation response comprises one or more sets of data, and wherein each set of data is accompanied by a specification that specifies a type of value being represented by that set of data.

10. The method of claim 1, wherein said operation response comprises an XML document.

11. The method of claim 1, wherein said transaction response comprises one or more sets of data, and wherein each set of data is accompanied by a specification that specifies a type of value being represented by that set of data.

12. The method of claim 1, wherein said transaction response comprises an XML document.

13. The method of claim 1, wherein the sender of said transaction request comprises a requesting application.

14. The method of claim 1, wherein the sender of said transaction request comprises a third transaction manager.

15. The method of claim 1, wherein said transaction request specifies a particular transaction type, and wherein determining at least one particular operation to be performed to process said transaction request comprises:
accessing a transaction definition associated with said particular transaction type, said transaction definition specifying one or more operations to be performed; and
obtaining said particular operation from said transaction definition.

16. The method of claim 15, wherein said transaction definition comprises one or more sets of data, and wherein each set of data is accompanied by a specification that specifies a type of value being represented by that set of data.

17. The method of claim 15, wherein said transaction definition comprises an XML document.

18. The method of claim 15, wherein said transaction definition further comprises conditional logic for controlling an order in which said one or more operations are to be performed, and wherein said particular operation is obtained from said transaction definition by carrying out at least a portion of said conditional logic.

19. The method of claim 15, wherein said transaction definition comprises a directed acyclic graph (DAG), and wherein obtaining said particular operation from said transaction definition comprises:
traversing said DAG.

20. The method of claim 19, wherein said DAG comprises conditional logic, and wherein said DAG is traversed based, at least partially, upon said conditional logic.

21. A method, implemented by a first transaction manager, for processing a transaction, comprising:
receiving a transaction request;
determining whether the first transaction manager is capable of processing said transaction request;
in response to a determination that the first transaction manager is not capable of processing said transaction request, sending an assistance request to a second transaction manager to ask the second transaction manager to coordinate processing of said transaction request;
receiving an assistance response from the second transaction manager after said transaction request has been processed; and
sending a transaction response to a sender of said transaction request, said transaction response comprising at least a portion of said assistance response.

22. The method of claim 21, wherein said transaction request comprises one or more sets of data, and wherein each set of data is accompanied by a specification that specifies a type of value being represented by that set of data.

23. The method of claim 21, wherein said transaction request comprises an XML document.

24. The method of claim 21, wherein said transaction response comprises one or more sets of data, and wherein each set of data is accompanied by a specification that specifies a type of value being represented by that set of data.

25. The method of claim 21, wherein said transaction response comprises an XML document.

26. The method of claim 21, wherein the sender of said transaction request comprises a requesting application.

27. The method of claim 21, wherein the sender of said transaction request comprises a third transaction manager.

28. The method of claim 21, wherein said transaction request specifies a particular transaction type, and wherein determining whether the first transaction manager is capable of processing said transaction request comprises:
determining whether the first transaction manager has access to a transaction definition associated with said particular transaction type.

29. A method, implemented by a first transaction manager, for coordinating performance of an operation, comprising:
receiving a first operation request from a second transaction manager requesting that the first transaction manger coordinate performance of a particular operation;
determining whether any of a plurality of service providers accessible to the first transaction manager are able to perform said particular operation;
in response to a determination that none of the plurality of service providers accessible to the first transaction manager are able to perform said particular operation, sending a second operation request to a third transaction manager to ask the third transaction manager to coordinate performance of said particular operation;
receiving a first operation response from the third transaction manager after said particular operation has been performed; and
sending a second operation response to the second transaction manager as a response to said first operation request, said second operation response comprising at least a portion of said first operation response.

30. The method of claim 29, further comprising:
in response to a determination that at least one of the plurality of service providers accessible to the first transaction manager is able to perform said particular operation, sending a third operation request to a particular service provider able to perform said particular operation;
receiving a third operation response from the particular service provider after said particular operation has been performed; and
sending a fourth operation response to the first transaction manager as a response to said first operation request, said fourth operation response comprising at least a portion of said third operation response.

31. The method of claim 28, wherein said first operation request comprises one or more sets of data, and wherein each set of data is accompanied by a specification that specifies a type of value being represented by that set of data.

32. The method of claim 28, wherein said first operation request comprises an XML document.

33. The method of claim 28, wherein said second operation response comprises one or more sets of data, and wherein each set of data is accompanied by a specification that specifies a type of value being represented by that set of data.

34. The method of claim 28, wherein said second operation response comprises an XML document.

35. A computer readable medium comprising instructions which, when executed by one or more processors, causes the one or more processors to give rise to a first transaction manager that performs the following:
receiving a transaction request;
determining at least one particular operation to be performed to process said transaction request;
determining whether any of a plurality of service providers accessible to the first transaction manager are able to perform said particular operation;
in response to a determination that none of the plurality of service providers accessible to the first transaction manager are able to perform said particular operation:
sending a first operation request to a second transaction manager to ask the second transaction manager to coordinate performance of said particular operation;
receiving a first operation response from the second transaction manager after said particular operation has been performed;
preparing a transaction response based, at least partially, upon said first operation response; and
sending said transaction response to a sender of said transaction request.

36. The computer readable medium of claim 35, wherein the first transaction manager further performs:
in response to a determination that at least one of the plurality of service providers accessible to the first transaction manager is able to perform said particular operation:
sending a second operation request to a particular service provider that is able to perform said particular operation;
receiving a second operation response from the particular service provider after said particular service provider has performed said particular operation; and
preparing said transaction response based, at least partially, upon said second operation response.

37. The computer readable medium of claim 36, wherein said first operation request and said second operation request are the same request.

38. The computer readable medium of claim 36, wherein said first operation request and said second operation request are different requests.

39. The computer readable medium of claim 35, wherein said transaction request comprises one or more sets of data, and wherein each set of data is accompanied by a specification that specifies a type of value being represented by that set of data.

40. The computer readable medium of claim 35, wherein said transaction request comprises an XML document.

41. The computer readable medium of claim 35, wherein said operation request comprises one or more sets of data, and wherein each set of data is accompanied by a specification that specifies a type of value being represented by that set of data.

42. The computer readable medium of claim 35, wherein said operation request comprises an XML document.

43. The computer readable medium of claim 35, wherein said operation response comprises one or more sets of data, and wherein each set of data is accompanied by a specification that specifies a type of value being represented by that set of data.

44. The computer readable medium of claim 35, wherein said operation response comprises an XML document.

45. The computer readable medium of claim 35, wherein said transaction response comprises one or more sets of data, and wherein each set of data is accompanied by a specification that specifies a type of value being represented by that set of data.

46. The computer readable medium of claim 35, wherein said transaction response comprises an XML document.

47. The computer readable medium of claim 35, wherein the sender of said transaction request comprises a requesting application.

48. The computer readable medium of claim 35, wherein the sender of said transaction request comprises a third transaction manager.

49. The computer readable medium of claim 35, wherein said transaction request specifies a particular transaction type, and wherein determining at least one particular operation to be performed to process said transaction request comprises:
accessing a transaction definition associated with said particular transaction type, said transaction definition specifying one or more operations to be performed; and
obtaining said particular operation from said transaction definition.

50. The computer readable medium of claim 49, wherein said transaction definition comprises one or more sets of data, and wherein each set of data is accompanied by a specification that specifies a type of value being represented by that set of data.

51. The computer readable medium of claim 49, wherein said transaction definition comprises an XML document.

52. The computer readable medium of claim 49, wherein said transaction definition further comprises conditional logic for controlling an order in which said one or more operations are to be performed, and wherein said particular operation is obtained from said transaction definition by carrying out at least a portion of said conditional logic.

53. The computer readable medium of claim 49, wherein said transaction definition comprises a directed acyclic graph (DAG), and wherein obtaining said particular operation from said transaction definition comprises:
traversing said DAG.

54. The computer readable medium of claim 53, wherein said DAG comprises conditional logic, and wherein said DAG is traversed based, at least partially, upon said conditional logic.

55. A computer readable medium comprising instructions which, when executed by one or more processors, causes the one or more processors to give rise to a first transaction manager that performs the following:
receiving a transaction request;
determining whether the first transaction manager is capable of processing said transaction request;
in response to a determination that the first transaction manager is not capable of processing said transaction request, sending an assistance request to a second transaction manager to ask the second transaction manager to coordinate processing of said transaction request;
receiving an assistance response from the second transaction manager after said transaction request has been processed; and
sending a transaction response to a sender of said transaction request, said transaction response comprising at least a portion of said assistance response.

56. The computer readable medium of claim 55, wherein said transaction request comprises one or more sets of data, and wherein each set of data is accompanied by a specification that specifies a type of value being represented by that set of data.

57. The computer readable medium of claim 55, wherein said transaction request comprises an XML document.

58. The computer readable medium of claim 55, wherein said transaction response comprises one or more sets of data, and wherein each set of data is accompanied by a specification that specifies a type of value being represented by that set of data.

59. The computer readable medium of claim 55, wherein said transaction response comprises an XML document.

60. The computer readable medium of claim 55, wherein the sender of said transaction request comprises a requesting application.

61. The computer readable medium of claim 55, wherein the sender of said transaction request comprises a third transaction manager.

62. The computer readable medium of claim 55, wherein said transaction request specifies a particular transaction type, and wherein determining whether the first transaction manager is capable of processing said transaction request comprises:
determining whether the first transaction manager has access to a transaction definition associated with said particular transaction type.

63. A computer readable medium comprising instructions which, when executed by one or more processors, causes the one or more processors to give rise to a first transaction manager that performs the following:
receiving a first operation request from a second transaction manager requesting that the first transaction manger coordinate performance of a particular operation;
determining whether any of a plurality of service providers accessible to the first transaction manager are able to perform said particular operation;
in response to a determination that none of the plurality of service providers accessible to the first transaction manager are able to perform said particular operation, sending a second operation request to a third transaction manager to ask the third transaction manager to coordinate performance of said particular operation;
receiving a first operation response from the third transaction manager after said particular operation has been performed; and
sending a second operation response to the second transaction manager as a response to said first operation request, said second operation response comprising at least a portion of said first operation response.

64. The computer readable medium of claim 63, wherein the first transaction manager further performs:
in response to a determination that at least one of the plurality of service providers accessible to the first transaction manager is able to perform said particular operation, sending a third operation request to a particular service provider able to perform said particular operation;
receiving a third operation response from the particular service provider after said particular operation has been performed; and
sending a fourth operation response to the first transaction manager as a response to said first operation request, said fourth operation response comprising at least a portion of said third operation response.

65. The computer readable medium of claim 63, wherein said first operation request comprises one or more sets of data, and wherein each set of data is accompanied by a specification that specifies a type of value being represented by that set of data.

66. The computer readable medium of claim 63, wherein said first operation request comprises an XML document.

67. The computer readable medium of claim 63, wherein said second operation response comprises one or more sets of data, and wherein each set of data is accompanied by a specification that specifies a type of value being represented by that set of data.

68. The computer readable medium of claim 63, wherein said second operation response comprises an XML document.

69. A distributed transaction processing system, comprising:
a first transaction manager having access to a first plurality of service providers; and
a second transaction manager having access to a second plurality of service providers; wherein
said first transaction manager receives a transaction request and determines at least one particular operation to be performed to process said transaction request, said first transaction manager determining whether any of the first plurality of service providers is able to perform said particular operation, and if none of the first plurality of service providers is able to perform said particular operation, said first transaction manager sending a first operation request to said second transaction manager to ask said second transaction manager to coordinate performance of said particular operation, said first transaction manager receiving a first operation response from said second transaction manager after said particular operation has been performed, said first transaction manager preparing a transaction response based, at least partially, upon said first operation response and sending said transaction response to a sender of said transaction request.

70. The system of claim 69, wherein said second transaction manager coordinates performance of said particular operation by determining whether any of the second plurality of service providers are able to perform said particular operation, and if at least one of the second plurality of service providers is able to perform said particular operation, said second transaction manager invoking a particular service provider that is able to perform said particular operation to cause the particular service provider to perform said particular operation, said second transaction manager sending said first operation response to said first transaction manager after said particular operation has been performed.

71. The system of claim 69, wherein said second transaction manager coordinates performance of said particular operation by determining whether any of the second plurality of service providers are able to perform said particular operation, and if none of the second plurality of service providers are able to perform said particular operation, said second transaction manager sending a second operation request to a third transaction manager to ask the third transaction manager to coordinate performance of said particular operation, said second transaction manager receiving a second operation response from the third transaction manager after said particular operation has been performed, said second transaction manager sending said first operation response to said first transaction manager thereafter, wherein said first operation response comprises at least a portion of said second operation response.

72. The system of claim 69, wherein said transaction request comprises one or more sets of data, and wherein each set of data is accompanied by a specification that specifies a type of value being represented by that set of data.

73. The system of claim 69, wherein said transaction request comprises an XML document.

74. The system of claim 69, wherein said transaction response comprises one or more sets of data, and wherein each set of data is accompanied by a specification that specifies a type of value being represented by that set of data.

75. The system of claim 69, wherein said transaction response comprises an XML document.

76. A distributed transaction processing system, comprising:
a first transaction manager; and
a second transaction manager, wherein
said first transaction manager receives a transaction request and determines whether said first transaction manager is able to processing said transaction request, and if said first transaction manager is unable to process said transaction request, said first transaction manager sending an assistance request to said second transaction manager to ask said second transaction manager to coordinate processing of said transaction request, said first transaction manager receiving an assistance response from said second transaction manager after said transaction request has been processed, and sending a transaction response to a sender of said transaction request, said transaction response comprising at least a portion of said assistance response.

77. The system of claim 76, wherein said transaction request comprises one or more sets of data, and wherein each set of data is accompanied by a specification that specifies a type of value being represented by that set of data.

78. The system of claim 76, wherein said transaction request comprises an XML document.

79. The system of claim 76, wherein said transaction response comprises one or more sets of data, and wherein each set of data is accompanied by a specification that specifies a type of value being represented by that set of data.

80. The system of claim 76, wherein said transaction response comprises an XML document.
